(19) United States
(12) Patent Application Publication
(10) Pub. No.: US 2026/0178781 A1
(43) Pub. Date: Jun. 25, 2026

(54) IMAGE PROCESSING APPARATUS, IMAGE CAPTURING APPARATUS, CONTROL METHOD, AND STORAGE MEDIUM

(71) Applicant: CANON KABUSHIKI KAISHA, Tokyo (JP)

(72) Inventor: Tomomi CHIBA, Tokyo (JP)

(21) Appl. No.: 19/422,550

(22) Filed: Dec. 17, 2025

(30) Foreign Application Priority Data
Dec. 19, 2024 (JP) 2024-224302

(51) Int. Cl. G06F 21/64; G06T 11/60; H04L 9/32

(52) U.S. Cl. CPC G06F 21/64; G06T 11/60; H04L 9/3236

(57) ABSTRACT

A generation unit generates a second image file including second image data by executing image editing processing on a first image file including first image data. If the first image file includes first authenticity ensuring information configured to ensure authenticity of the first image data, a verification unit verifies authenticity of the first image data based on the first authenticity ensuring information. If the verification of authenticity of the first image data succeeds, a control unit includes second authenticity ensuring information configured to ensure authenticity of the second image data in the second image file. If the verification of authenticity of the first image data fails or the first image file does not include the first authenticity ensuring information, the control unit refrains from including the second authenticity ensuring information in the second image file.

### BACKGROUND

### Field of the Technology

The present disclosure relates to an image processing apparatus, an image capturing apparatus, a control method, and a storage medium.

### Description of the Related Art

Conventionally, the ability to ensure the authenticity of an image, that is to say ensure that an image has not been tampered with, has been required in a variety of scenarios. Examples of such scenarios include ensuring that an image to be handled by the police has not been tampered with, and ensuring that an image to be posted in a newspaper or online news has not been tampered with.

Japanese Patent Laid-Open No. 2008-124668 discloses a technique for not only enabling verification of whether original content has been tampered with, but also enabling specification of all editing processing by appending an editing history.

Also, recent years have seen the founding of a technology standardization association called Coalition for Content Provenance and Authenticity (C2PA), which aims to develop technological specifications that enable ensuring the source and reliability of content, and to enable publishing companies, creators, and consumers to track the source of media, and the necessity of ensuring authenticity has been receiving attention. With the standards of C2PA, it is possible to save a Manifest as C2PA data in a generated image at the time of shooting or editing. An actor (the name of the camera or software that generated the image), a hash value, a claim signature (digital signature), a thumbnail image, and the like can be stored in the Manifest.

According to Japanese Patent Laid-Open No. 2008-124668, authenticity ensuring information is added during editing, regardless of whether the original content has been tampered with, and therefore it is difficult to say that the reliability of edited content is sufficiently ensured.

### SUMMARY

The present disclosure provides, in at least a part of aspects thereof, a technique to refrain from including authenticity ensuring information in an image file that includes edited image data in a case where verification of authenticity of original image data has failed.

According to one aspect of the present disclosure, there is provided an image processing apparatus, comprising: a generation unit configured to generate a second image file by executing image editing processing on a first image file including first image data, the second image file including second image data that reflects the image editing processing; a verification unit configured to, in a case where the first image file includes first authenticity ensuring information configured to ensure authenticity of the first image data, verify authenticity of the first image data based on the first authenticity ensuring information; and a control unit configured to perform control to in a case where the verification of authenticity of the first image data succeeds, include second authenticity ensuring information configured to ensure authenticity of the second image data in the second image file, and in a case where the verification of authenticity of the first image data fails or the first image file does not include the first authenticity ensuring information, refrain from including the second authenticity ensuring information in the second image file.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing an exemplary configuration of a digital camera 100.

FIG. 2A is a diagram showing an exemplary configuration of an image file.

FIG. 2B is a diagram showing an example of an image file including an authenticity ensuring information region 207 that includes a plurality of pieces of authenticity ensuring information.

FIG. 3 is a flowchart of processing for adding authenticity ensuring information at the time of editing of an image according to a first embodiment.

FIG. 4 is a diagram for describing an example of a change in an image file involved in processing of FIG. 3.

FIG. 5 is a flowchart of processing for adding authenticity ensuring information at the time of editing of an image according to a second embodiment.

FIGS. 6A and 6B are diagrams for describing an example of a change in an image file involved in processing of FIG. 5.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

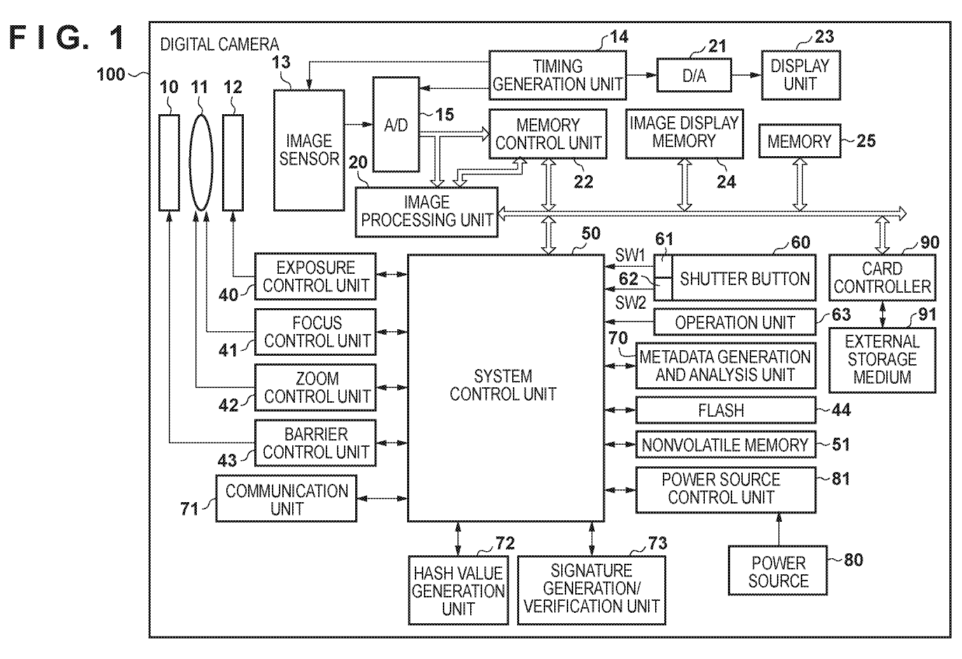

FIG. 1 is a block diagram showing an exemplary configuration of a digital camera 100. The digital camera 100 is an example of an image capturing apparatus that includes an image processing apparatus. The image capturing apparatus may be, for example, a smartphone. Also, a personal computer (PC) that does not include a camera can fulfill the role of the image processing apparatus of the present embodiment.

A barrier 10 is a protection member that covers an image capturing unit of the digital camera 100, which includes a shooting lens 11, thereby preventing the image capturing unit from getting stained or damaged; operations thereof are controlled by a barrier control unit 43. The shooting lens 11 causes an optical image to be formed on an image capturing surface of an image sensor 13. A shutter 12 has a diaphragm function. The image sensor 13 is composed of, for example, a CCD or CMOS sensor and the like, and converts the optical image that has been formed on the image capturing surface by the shooting lens 11 via the shutter 12 into electrical signals.

An A/D converter 15 converts analog image signals output from the image sensor 13 into digital image signals. The digital image signals converted by the A/D converter 15 are written to a memory 25 as pieces of so-called RAW image data. In addition to this, development parameters corresponding to the respective pieces of RAW image data are generated based on information at the time of shooting, and written to the memory 25. The development parameters are composed of various types of parameters, such as exposure settings, white balance, a color space, and contrast, which are used in image processing for recording images in accordance with a JPEG method and the like.

A timing generator 14 is controlled by a memory control unit 22 and a system control unit 50, and supplies clock signals and control signals to the image sensor 13, the A/D converter 15, and a D/A converter 21.

An image processing unit 20 executes various types of image processing, such as predetermined pixel interpolation processing, color conversion processing, correction processing, resize processing, and image composition processing, with respect to data from the A/D converter 15 or data from the memory control unit 22. Also, the image processing unit 20 executes predetermined image processing and computation processing with use of image data obtained through image capture, and provides the obtained computation result to the system control unit 50. The system control unit 50 realizes autofocus (AF) processing, automatic exposure (AE) processing, and preliminary flash emission (EF) processing by controlling an exposure control unit 40 and a focus control unit 41 based on the provided computation result.

Also, the image processing unit 20 executes predetermined computation processing with use of image data obtained through image capture, and further executes auto white balance (AWB) processing based on the obtained computation result. Furthermore, the image processing unit 20 reads in image data stored in the memory 25, and executes compression processing or decompression processing in accordance with, for example, the JPEG method, an MPEG-4 AVC method, a High Efficiency Video Coding (HEVC) method, or a lossless compression method for uncompressed RAW data. Then, the image processing unit 20 writes the image data for which processing has been completed to the memory 25.

Also, the image processing unit 20 executes predetermined computation processing with use of image data obtained through image capture, and executes editing processing with respect to various types of image data. Specifically, it can execute trimming processing for adjusting the display range and size of an image by causing unnecessary parts around image data not to be displayed, and resize processing for changing the size by enlarging or reducing image data, display elements of a screen, and the like. Furthermore, the image processing unit 20 can perform RAW development whereby image data is created by applying image processing, such as color conversion, to data that has undergone compression processing in accordance with, for example, a lossless compression method for uncompressed RAW data, or decompression processing, and converting the resultant data into data of the JPEG method or the HEVC method. Moreover, the image processing unit 20 can execute moving image cutout processing in which a designated frame of a moving image format, such as MPEG-4, is cut out, converted into data of the JPEG method, and saved.

Also, the image processing unit 20 executes predetermined computation processing with use of image data, and executes image comparison processing with respect to various types of image data. Specifically, it executes decompression processing in accordance with a compression method of image data to be compared, and makes the comparison with use of the decompressed image. The image processing unit 20 can determine whether images match, and the extent of the difference.

Furthermore, the image processing unit 20 also executes, for example, processing for superimposing an On-Screen Display (OSD), such as a menu and any character to be displayed on a display unit 23, over image data for display.

Also, the image processing unit 20 executes subject detection processing for detecting a subject that exists within image data and detecting a subject region thereof with use of, for example, input image data and information of a distance to the subject, which is obtained from the image sensor 13 and the like at the time of shooting. Region information indicating a position and a size inside an image, and detection information indicating an inclination, likelihood, and the like, can be obtained as detectable information.

Furthermore, the image processing unit 20 includes a composition processing circuit that composites a plurality of pieces of image data. In the present embodiment, the image processing unit 20 may composite images by way of processing for overwriting pixels, or may composite images by way of weighted addition. Performing the weighted addition can achieve an image in which a background looks see-through. Also, the image processing unit 20 can execute lighten composition processing or darken composition processing for selecting an image with the brightest value or the darkest value in each region of pieces of image data to be composited, and generating one piece of image data by compositing images that have been selected on a per-pixel basis.

The memory control unit 22 controls the A/D converter 15, the timing generator 14, the image processing unit 20, an image display memory 24, the D/A converter 21, and the memory 25. RAW image data generated by the A/D converter 15 is written to the image display memory 24 or the memory 25 via the image processing unit 20 and the memory control unit 22, or directly via the memory control unit 22.

The image data for display that has been written to the image display memory 24 is displayed on the display unit 23, which is composed of a TFT LCD and the like, via the D/A converter 21. An electronic viewfinder function for displaying live images can be realized by sequentially displaying pieces of image data obtained through image capture with use of the display unit 23.

The memory 25 has a storage capacity that is sufficient to store a predetermined number of still images and moving images of a predetermined duration, and stores still images and moving images that have been shot. Furthermore, the memory 25 can also be used as a working area for the system control unit 50.

The exposure control unit 40 controls the shutter 12, which has a diaphragm function. Furthermore, the exposure control unit 40 also realizes a flash light adjustment function by operating in coordination with a flash 44. The focus control unit 41 performs focus adjustment by driving a non-illustrated focus lens, which is included in the shooting lens 11, based on an instruction from the system control unit 50. A zoom control unit 42 controls zooming by driving a non-illustrated zoom lens, which is included in the shooting lens 11. The flash 44 has a function of projecting AF auxiliary light, and a flash light adjustment function.

The system control unit 50 controls the entirety of the digital camera 100. A nonvolatile memory 51 is an electrically erasable and recordable nonvolatile memory; for example, an EEPROM or the like is used thereas. Note that not only programs, but also map information and the like are recorded in the nonvolatile memory 51.

A shutter switch 61 (SW1) is turned ON and issues an instruction for starting operations of AF processing, AE processing, AWB processing, EF processing, and the like during an operation on a shutter button 60. A shutter switch 62 (SW2) is turned ON and issues an instruction for starting a series of shooting operations, including exposure processing, development processing, and recording processing, upon completion of the operation on the shutter button 60. In the exposure processing, the system control unit 50 performs control so that signals that have been read out from the image sensor 13 are written to the memory 25 as RAW image data via the A/D converter 15 and the memory control unit 22. In the development processing, the system control unit 50 performs control so that RAW image data that has been written to the memory 25 is developed with use of computation in the image processing unit 20 and the memory control unit 22, and written to the memory 25 as image data. In the recording processing, the system control unit 50 performs control so that image data is read out from the memory 25, the image processing unit 20 compresses the image data, and the compressed image data is stored to the memory 25 and then written to an external storage medium 91 via a card controller 90.

An operation unit 63 includes such operation members as various types of buttons and a touch panel. For example, the operation unit 63 includes a power source button, a menu button, a mode changing switch for switching among a shooting mode, a reproduction mode, and other special shooting modes, directional keys, a set button, a macro button, and a multi-screen reproduction page break button. Also, for example, the operation unit 63 includes a flash setting button, a button for switching among single shooting, continuous shooting, and self-timer, a menu transition + (plus) button, a menu transition − (minus) button, a shooting image quality selection button, an exposure correction button, a date/time setting button, and so forth.

When image data is to be recorded in the external storage medium 91, a metadata generation and analysis unit 70 generates various types of metadata, such as Exchangeable image file format (Exif) information to be attached to the image data, based on information at the time of shooting. Also, when image data recorded in the external storage medium 91 has been read in, the metadata generation and analysis unit 70 analyzes metadata added to the image data. Examples of metadata include various types of setting information at the time of shooting, image data information related to image data, feature information of a subject included in image data, and so forth. Furthermore, when moving image data is to be recorded, the metadata generation and analysis unit 70 can also generate and add metadata with respect to each frame.

A power source 80 is composed of, for example, a primary battery such as an alkaline battery and a lithium battery, a secondary battery such as a NiCd battery, a NiMH battery, and a Li battery, or an AC adapter. A power source control unit 81 supplies power supplied from the power source 80 to each unit of the digital camera 100.

The card controller 90 exchanges data with the external storage medium 91, which is a memory card or the like. The external storage medium 91 is composed of, for example, a memory card; images (still images and moving images) shot by the digital camera 100 are recorded therein.

A communication unit 71 includes a communication circuit for transmitting and receiving data. The communication circuit may be configured to perform wireless communication specifically via Wi-Fi, Bluetooth^{®}, and the like, or may be configured to perform wired communication via Ethernet, a USB, and the like.

A hash value generation unit 72 generates (calculates) a hash value by executing a hash function with respect to various types of data (e.g., image data, metadata, or the like) that have been input via the system control unit 50. The algorithms that generate a hash value are SHA-256, SHA-384, SHA-512, and so forth. Note that a hash value may be generated by the system control unit 50 in place of the hash value generation unit 72. Also, the hash value generation unit 72 may generate a hash value by executing the hash function with respect to an entire image file, rather than image data.

A signature generation/verification unit 73 generates and verifies signature information that is necessary to determine whether authenticity is ensured. At the time of image creation, the signature generation/verification unit 73 generates signature information with use of a hash value of image data generated by the hash value generation unit 72 and a signature generation key (secret key), and records the signature information as authenticity ensuring information in an image file. At the time of detection of tampering of an image, the signature generation/verification unit 73 judges whether tampering has been done by verifying a hash value of verification target image data generated by the hash value generation unit 72 and a signature recorded as authenticity ensuring information with use of a public key. The algorithms for generation and verification of signature information are ECDSA, RSASSA-PSS, EdDSA, and so forth. Note that the role of the signature generation/verification unit 73 may be taken by the system control unit 50 in place of the signature generation/verification unit 73.

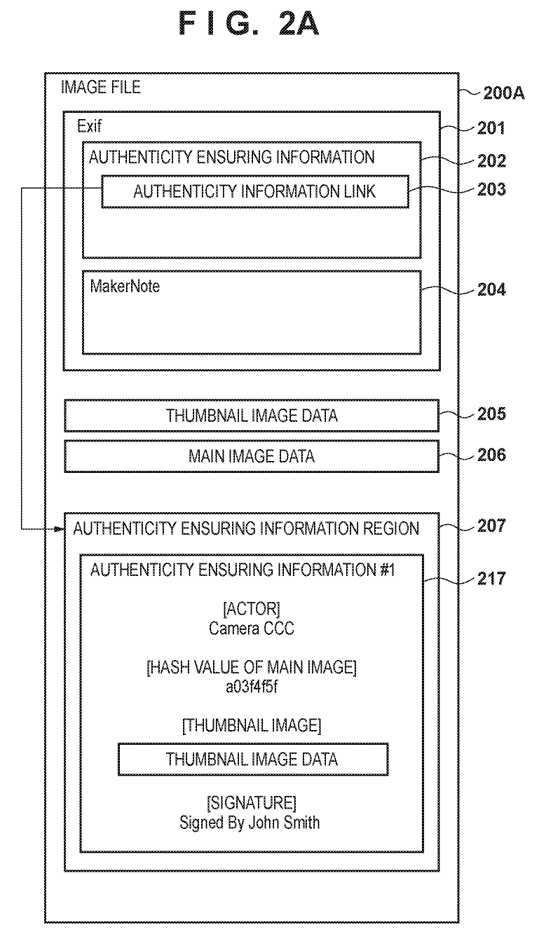

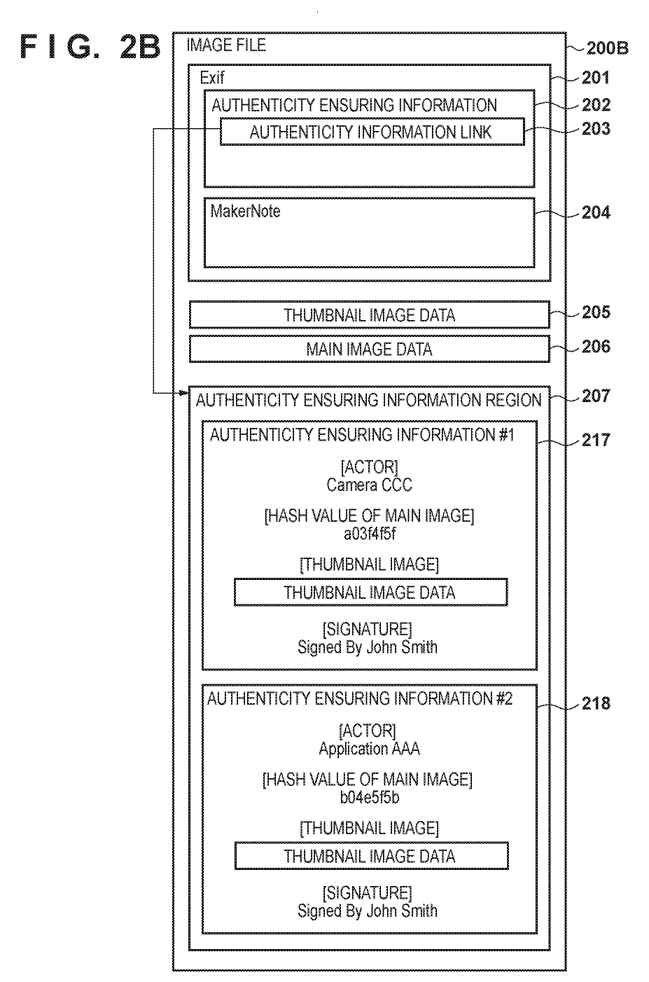

FIG. 2A is a diagram showing an exemplary configuration of an image file. An image file 200A recorded in the present embodiment includes a region for recording metadata conforming with the Exif standard (Exif data 201), a region for recording compressed main image data 206, and a region for recording authenticity ensuring information 217 (an authenticity ensuring information region 207).

For example, in a case where a user has issued an instruction for recording in a JPEG format, thumbnail image data 205 and the main image data 206 are recorded in the image file 200A in the JPEG format. Also, the Exif data 201 is recorded in an APP1 marker and the like, and the authenticity ensuring information region 207 is recorded in an APP11 marker and the like.

Furthermore, in a case where the user has issued an instruction for recording in a High Efficiency Image File Format (HEIF) format, the image file 200A is recorded in the HEIF file format, and the Exif data 201 and the authenticity ensuring information region 207 are recorded in a Meta data Box and the like. In addition, also in a case where the user has issued an instruction for recording in a RAW format, the Exif data 201 and the authenticity ensuring information region 207 are similarly recorded in a predetermined region, such as a Meta data Box.

The image file 200A is not limited to the above-described formats, and is recorded in other formats in some cases.

Information 202 indicating whether the authenticity ensuring information exists, and a link 203 to the authenticity ensuring information, may be recorded in the Exif data 201. Furthermore, there are cases where manufacturer-specific metadata that has been generated using the metadata generation and analysis unit 70 is described inside MakerNote 204, which is included in the Exif data 201, in a non-public format as a general rule.

The authenticity ensuring information region 207 includes the authenticity ensuring information 217 (first authenticity ensuring information), which includes information for ensuring the authenticity of the main image data 206. The authenticity ensuring information 217 includes an actor (a name of a camera or software that has generated or edited an image), one or more hash values, thumbnail image data, a signature, and so forth. It is assumed here that the authenticity ensuring information 217 is information that was added to (associated with) the main image data 206 by the digital camera 100 when the digital camera 100 generated the main image data 206.

The thumbnail image data is thumbnail image data that corresponds to the main image data 206 at the time of addition of the authenticity ensuring information 217 to the image file 200A.

The authenticity ensuring information 217 can include a hash value of a main image, a hash value of metadata, a hash value of the main image and the metadata, and the like as one or more hash values. One or more hash values included in the authenticity ensuring information 217 have been signed.

The hash value of the main image is a hash value calculated based on main image data (the main image data 206 in the example of FIG. 2A). Therefore, in a case where the authenticity ensuring information 217 includes the hash value of the main image, it can be said that the authenticity ensuring information 217 is configured to ensure the authenticity of the main image data 206.

The hash value of the metadata is a hash value calculated based on the metadata (the Exif data 201 in the example of FIG. 2A). Therefore, in a case where the authenticity ensuring information 217 includes the hash value of the metadata, it can be said that the authenticity ensuring information 217 is configured to ensure the authenticity of the metadata (Exif data 201).

The hash value of the main image and the metadata is a hash value calculated based on a combination of the main image data and the metadata (a combination of the main image data 206 and the Exif data 201 in the example of FIG. 2A). Therefore, in a case where the authenticity ensuring information 217 includes the hash value of the main image and the metadata, it can be said that the authenticity ensuring information 217 is configured to ensure the authenticities of the main image data 206 and the metadata (Exif data 201) in an integrated manner.

Note that in a case where authenticity verification based on the hash value of the main image and the metadata has succeeded, it can be considered that both of the main image data 206 and the metadata (Exif data 201) are authentic. Therefore, the authenticity ensuring information 217 that includes the hash value of the main image and the metadata is included as an example of authenticity ensuring information configured to ensure the authenticity of the main image data 206, similarly to the authenticity ensuring information 217 that includes the hash value of the main image. Furthermore, the authenticity ensuring information 217 that includes the hash value of the main image and the metadata is included as an example of authenticity ensuring information configured to ensure the authenticity of the metadata (Exif data 201), similarly to the authenticity ensuring information 217 that includes the hash value of the metadata.

In the example of FIG. 2A, the authenticity ensuring information 217 includes only the hash value of the main image as one or more hash values. However, the authenticity ensuring information 217 may include the hash value of the main image and the metadata, or may include two or more types of hash values, in place of the hash value of the main image. For example, the authenticity ensuring information 217 may include each of the hash value of the main image and the hash value of the metadata. In this case, it can be said that the authenticity ensuring information 217 is configured to ensure the authenticities of the main image data 206 and the metadata (Exif data 201) on an individual basis. The authenticity ensuring information 217 that includes each of the hash value of the main image and the hash value of the metadata is included as an example of authenticity ensuring information configured to ensure the authenticity of the main image data 206, and is also included as an example of authenticity ensuring information configured to ensure the authenticity of the metadata.

In the example of FIG. 2A, the authenticity ensuring information region 207 includes one piece of authenticity ensuring information (authenticity ensuring information 217). However, there are cases where the authenticity ensuring information region 207 includes a plurality of pieces of authenticity ensuring information.

FIG. 2B is a diagram showing an example of an image file including an authenticity ensuring information region 207 that includes a plurality of pieces of authenticity ensuring information. An image file 200B of FIG. 2B is an image file generated by executing image editing processing with respect to the image file 200A with use of an image editing application. Therefore, the content of main image data 206 (second image data) of the image file 200B (second image file) is different from the content of the main image data 206 (first main image data) of the image file 200A (first image file).

The image editing processing may include processing that triggers a change in metadata. For example, in a case where the metadata includes information indicating a direction of an image and image editing processing that includes processing for rotating the image has been executed, the information indicating the direction of the image included in the metadata changes. Therefore, the content of Exif data 201 (second metadata) of the image file 200B (second image file) is different from the content of the Exif data 201 (first metadata) of the image file 200A (first image file).

In FIG. 2B, the authenticity ensuring information region 207 includes authenticity ensuring information 218 in addition to the authenticity ensuring information 217. The authenticity ensuring information 218 is information that was added to (associated with) the main image data 206 by the image editing application at the time of recording of the main image data 206 that has already been edited (the image data that reflects the image editing processing).

A hash value of a main image included in the authenticity ensuring information 218 is a hash value calculated based on the main image data 206 at the time of addition of the authenticity ensuring information 218 to the image file 200B. Therefore, the hash value of the main image included in the authenticity ensuring information 218 has a value different from the hash value of the main image included in the authenticity ensuring information 217.

Thumbnail image data included in the authenticity ensuring information 218 is thumbnail image data that corresponds to the main image data 206 at the time of addition of the authenticity ensuring information 218 to the image file 200B.

In the example of FIG. 2B, the newest authenticity ensuring information is the second (the lowest) authenticity ensuring information 218. When recording authenticity ensuring information in the authenticity ensuring information region 207, the system control unit 50 may store, at the top of the authenticity ensuring information region 207, such management information as a link to the authenticity ensuring information, the order of the authenticity ensuring information (the order in which it has been recorded), and the total number of pieces of authenticity ensuring information that have already been recorded.

As the image file 200B includes the pieces of authenticity ensuring information 217 and 218, the digital camera 100 can confirm the authentic provenance of the main image data 206.

In the present embodiment, as long as a condition that has been determined in advance (the details will be described later) is satisfied, new authenticity ensuring information is added each time the main image data 206 is edited and recorded.

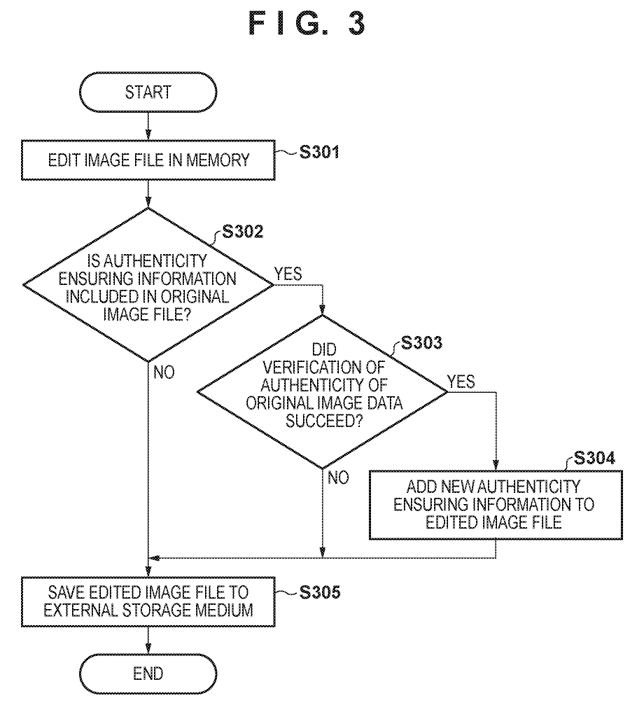

FIG. 3 is a flowchart of processing for adding authenticity ensuring information at the time of editing of an image according to the first embodiment. It is assumed here that the digital camera 100 fulfills a role as an image processing apparatus, and a user executes image editing processing with respect to the image file 200A with use of the image editing application on the digital camera 100. The main image data 206 of the image file 200A corresponds to an image that has been shot using the image sensor 13. The functions of the image editing application are realized by the system control unit 50 executing a program of the image editing application stored in the nonvolatile memory 51. The system control unit 50 uses the memory 25 as a working area at the time of execution of the program of the image editing application.

Note that the image processing apparatus that executes the image editing application is not limited to the digital camera 100. For example, a PC may fulfill a role as an image processing apparatus, and the user may edit the main image data 206 of the image file 200A with use of an image editing application on the PC. In this case, the PC executes processing of FIG. 3.

In step S301, the system control unit 50 reads out the image file 200A from the external storage medium 91, and deploys the same to the memory 25. Then, the system control unit 50 executes the image editing processing on the memory 25 in conformity with a user instruction via the operation unit 63. In accordance with the content of editing instructed by the user, the contents of various types of data (e.g., the main image data 206 or the Exif data 201) of the image file 200A deployed to the memory 25 are changed. Once the user has issued an instruction for completing editing, processing proceeds to step S302. Note that in step S301, the system control unit 50 may execute the image editing processing with use of the image processing unit 20 as necessary.

In step S302, the system control unit 50 determines whether the original (unedited) image file 200A stored in the external storage medium 91 includes authenticity ensuring information configured to ensure the authenticity of the main image data 206. In a case where the original image file 200A includes the authenticity ensuring information, processing proceeds to step S303; otherwise, processing proceeds to step S305. In the example of FIG. 2A, as the image file 200A includes the authenticity ensuring information 217 configured to ensure the authenticity of the main image data 206, processing proceeds to step S303.

In step S303, the system control unit 50 verifies the authenticity of the main image data 206 (original main image data) of the original image file 200A based on the authenticity ensuring information 217, and determines whether the verification has succeeded. To verify the authenticity, the system control unit 50 determines whether a hash value of the main image stored in the authenticity ensuring information 217 and a hash value that has been recalculated based on the original main image data 206 match with use of the hash value generation unit 72 and the signature generation/verification unit 73. In a case where these two hash values match, the system control unit 50 judges that the authenticity verification has succeeded, and causes processing to proceed to step S304. In a case where these two hash values do not match, the system control unit 50 judges that the authenticity verification has failed, and causes processing to proceed to step S305. Note that in the following description, the success in the authenticity verification based on the authenticity ensuring information may be expressed as "the authenticity ensuring information is correct", and the failure in the authenticity verification may be expressed as "the authenticity ensuring information is incorrect".

In step S304, the system control unit 50 adds, to the edited image file stored in the memory 25, new authenticity ensuring information (e.g., the authenticity ensuring information 218 shown in FIG. 2B) configured to ensure the authenticity of the edited main image data 206.

In step S305, the system control unit 50 writes the edited image file (e.g., the image file 200B shown in FIG. 2B) including the edited image data to the external storage medium 91. At this time, the system control unit 50 may perform so-called "overwrite save" in which the unedited image file is replaced with the edited image file, or may perform so-called "save with different name" in which the edited image file is additionally saved while leaving the unedited image file.

In this way, in a case where processing of step S304 has been executed (in a case where the authenticity ensuring information of the original image file is correct), new authenticity ensuring information (e.g., the authenticity ensuring information 218 shown in FIG. 2B) is added to the edited image file. On the other hand, in a case where processing of step S304 has not been executed (in a case where the authenticity ensuring information of the original image file is incorrect, or the original image file does not include the authenticity ensuring information), new authenticity ensuring information is not added to the edited image file.

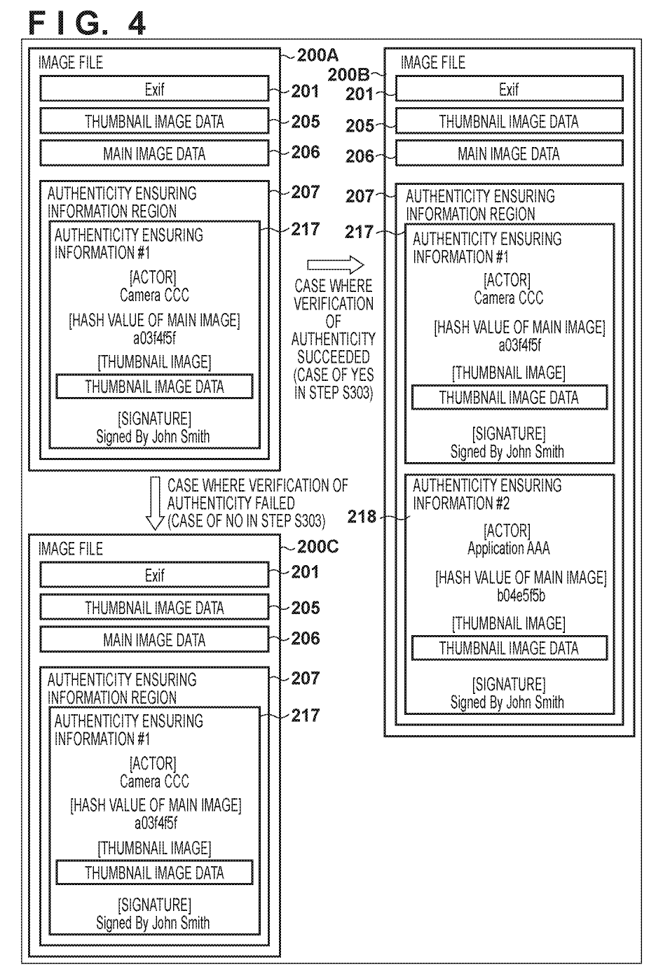

With reference to FIG. 4, a description is now given of an example of a change in an image file involved in processing of FIG. 3. In FIG. 4, an image file 200A is an unedited image file (first image file), and image files 200B and 200C are edited image files (second image files). The main image data 206 (second image data) of the image files 200B and 200C is image data that already reflects the image editing processing (i.e., image data obtained by adding a change to the main image data 206 (first image data) of the image file 200A).

In a case where processing has made a transition to step S305 via step S304 (in a case where the authenticity ensuring information 217 of the original image file 200A is correct), the edited image file 200B to which the new authenticity ensuring information 218 has been added is generated.

On the other hand, in a case where processing has made a transition from step S303 to step S305 without going through step S304 (in a case where the authenticity ensuring information 217 of the original image file 200A is incorrect), the image file 200C that does not include the new authenticity ensuring information 218 is generated. In this case, the system control unit 50 may append, to a header of the image file 200C, a flag indicating that the authenticity ensuring information 217 is now old information.

Furthermore, although omitted in the drawings, an edited image file that does not include the authenticity ensuring information 218 is generated also in a case where the original image file 200A does not include the authenticity ensuring information 217 (a case where processing has made a transition directly from step S302 to step S305).

Note that it is also possible to use an image file that includes a plurality of pieces of authenticity ensuring information as an original image file in executing processing of FIG. 3. For example, assume a case where the image file 200B is the original image file. In this case, in step S303, the system control unit 50 verifies the authenticity of the main image data 206 of the original image file 200B based on the authenticity ensuring information 218, and determines whether the verification has succeeded. In a case where the verification has succeeded, the system control unit 50 adds, to the edited image file stored in the memory 25, new authenticity ensuring information configured to ensure the authenticity of the edited main image data 206 in step S304. As a result, an image file that includes three pieces of authenticity ensuring information is generated.

As described above, according to the first embodiment, the digital camera 100 executes the image editing processing with respect to a first image file including first image data (e.g., the main image data 206 of the image file 200A), thereby generating a second image file including second image data (e.g., the main image data 206 of the image file 200B or 200C) that already reflects the image editing processing. Also, in a case where the first image file includes first authenticity ensuring information (e.g., the authenticity ensuring information 217 of the image file 200A) configured to ensure the authenticity of the first image data, the digital camera 100 verifies the authenticity of the first image data based on the first authenticity ensuring information. In a case where verification of the authenticity of the first image data has succeeded, the digital camera 100 performs control to include second authenticity ensuring information (e.g., the authenticity ensuring information 218 of the image file 200B) configured to ensure the authenticity of the second image data in the second image file. In a case where verification of the authenticity of the first image data has failed or the first image file does not include the first authenticity ensuring information, the digital camera 100 performs control to refrain from including the second authenticity ensuring information in the second image file.

In this way, according to the present embodiment, in a case where verification of the authenticity of original image data has succeeded, new authenticity ensuring information for edited image data is added to an edited image file. On the other hand, in a case where verification of the authenticity of original image data has failed or authenticity ensuring information for the original image data cannot be used, new authenticity ensuring information is not added to an edited image file. Therefore, for example, in a case where verification of the authenticity of the main image data 206 of the image file 200B has succeeded based on the authenticity ensuring information 218, it is considered that unedited main image data was also authentic. Accordingly, the present embodiment improves the reliability of image data that accompanies authenticity ensuring information.

### Second Embodiment

A second embodiment will be described in relation to exemplary processing for a case where authenticity ensuring information is configured to ensure the authenticities of main image data and metadata on an individual basis (e.g., a case where the authenticity ensuring information includes each of a hash value of a main image and a hash value of metadata). In the second embodiment, a basic configuration of the digital camera 100 is similar to that of the first embodiment. The following mainly describes the differences from the first embodiment.

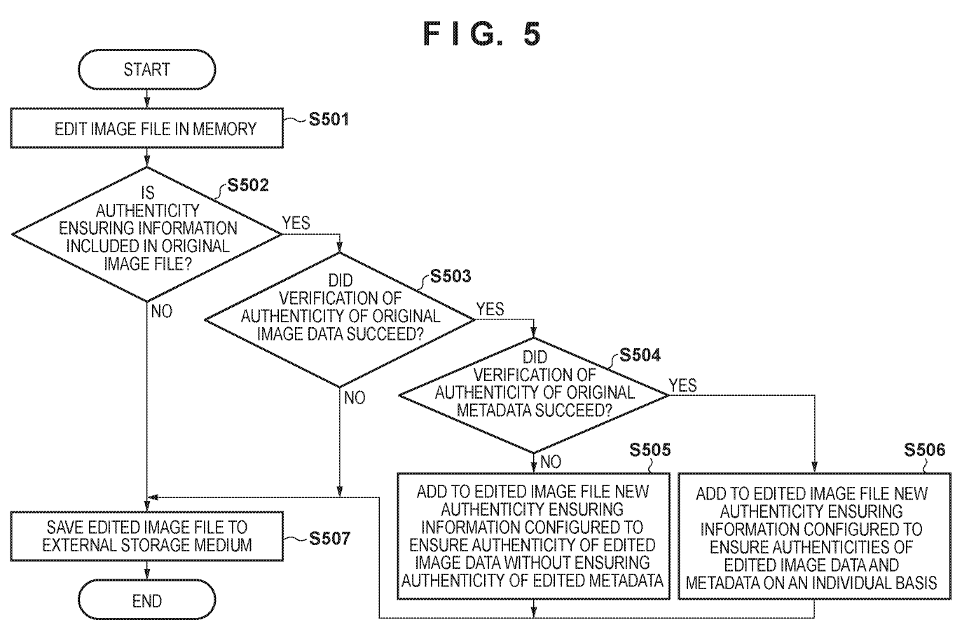

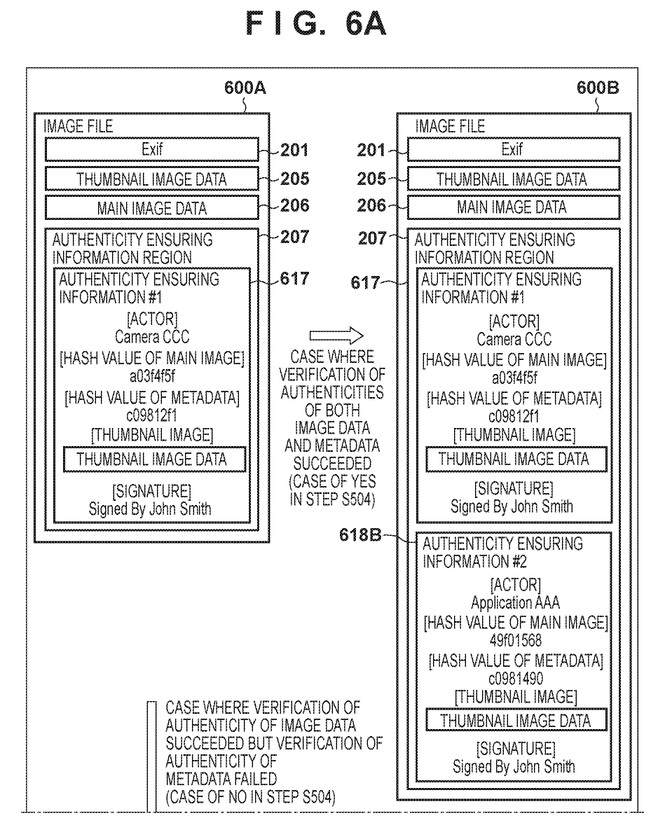

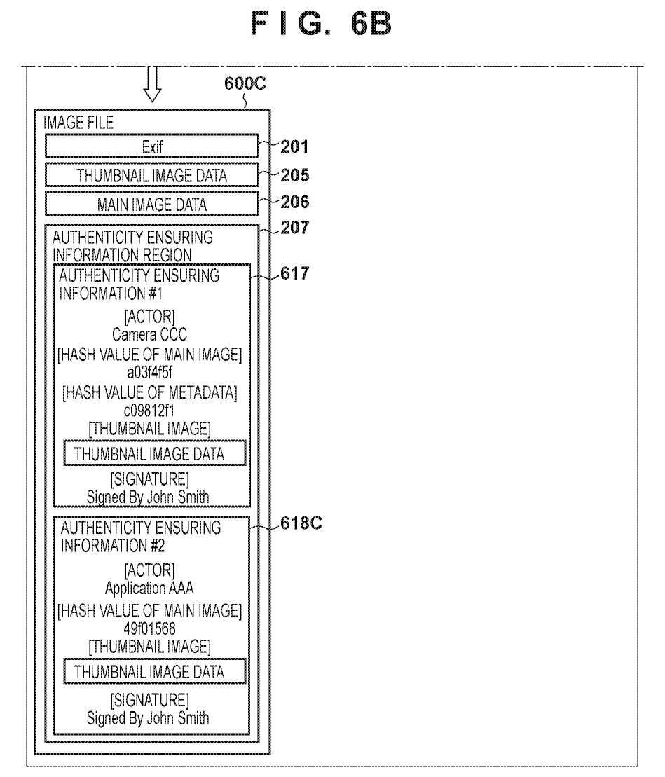

FIG. 5 is a flowchart of processing for adding authenticity ensuring information at the time of editing of an image according to the second embodiment. It is assumed here that the digital camera 100 fulfills a role as an image processing apparatus, and a user executes image editing processing with respect to an image file 600A shown in FIG. 6A with use of the image editing application on the digital camera 100. The functions of the image editing application are realized by the system control unit 50 executing a program of the image editing application stored in the nonvolatile memory 51. The system control unit 50 uses the memory 25 as a working area at the time of execution of the program of the image editing application. Similarly to the first embodiment, a PC may fulfill a role as an image processing apparatus.

Authenticity ensuring information 617 of the image file 600A includes each of a hash value of a main image and a hash value of metadata. Therefore, the authenticity ensuring information 617 is configured to ensure the authenticities of main image data 206 and metadata (Exif data 201) on an individual basis. The main image data 206 of the image file 600A corresponds to an image that has been shot using the image sensor 13.

Processing of steps S501 and S502 is similar to steps S301 and S302 of FIG. 3.

In step S503, the system control unit 50 verifies the authenticity of the main image data 206 (original main image data) of the original image file 600A based on the authenticity ensuring information 617, and determines whether the verification has succeeded. To verify the authenticity, the system control unit 50 determines whether the hash value of the main image stored in the authenticity ensuring information 617 and a hash value that has been recalculated based on the original main image data 206 match with use of the hash value generation unit 72 and the signature generation/verification unit 73. In a case where these two hash values match, the system control unit 50 judges that the authenticity verification has succeeded, and causes processing to proceed to step S504. In a case where these two hash values do not match, the system control unit 50 judges that the authenticity verification has failed, and causes processing to proceed to step S507.

In step S504, the system control unit 50 verifies the authenticity of the metadata (Exif data 201) of the original image file 600A based on the authenticity ensuring information 617, and determines whether the verification has succeeded. To verify the authenticity, the system control unit 50 determines whether the hash value of the metadata stored in the authenticity ensuring information 617 and a hash value that has been recalculated based on the original metadata (the Exif data 201 of the image file 600A) match with use of the hash value generation unit 72 and the signature generation/verification unit 73. In a case where these two hash values match, the system control unit 50 judges that the authenticity verification has succeeded, and causes processing to proceed to step S506. In a case where these two hash values do not match, the system control unit 50 judges that the authenticity verification has failed, and causes processing to proceed to step S505.

In step S505, the system control unit 50 adds, to an edited image file (e.g., an image file 600C of FIG. 6B) stored in the memory 25, new authenticity ensuring information (e.g., authenticity ensuring information 618C) configured to ensure the authenticity of the edited main image data 206. The authenticity ensuring information 618C does not include the hash value of the metadata, but includes the hash value of the main image. The hash value of the main image is calculated based on the edited main image data 206. Therefore, the authenticity ensuring information 618C is configured to ensure the authenticity of the main image data 206 of the image file 600C, without ensuring the authenticity of the metadata (Exif data 201) of the image file 600C.

In step S506, the system control unit 50 adds, to an edited image file (e.g., an image file 600B of FIG. 6A) stored in the memory 25, new authenticity ensuring information (e.g., authenticity ensuring information 618B) configured to ensure the authenticity of the edited main image data 206. The authenticity ensuring information 618B includes both of the hash value of the main image and the hash value of the metadata. The hash value of the main image is calculated based on the edited main image data 206. The hash value of the metadata is calculated based on the edited metadata. Therefore, the authenticity ensuring information 618B is configured to ensure the authenticities of the main image data 206 and the metadata (Exif data 201) of the image file 600B on an individual basis.

In step S507, the system control unit 50 writes the edited image file (e.g., the image file 600B or 600C shown in FIGS. 6A and 6B) including the edited image data to the external storage medium 91. At this time, the system control unit 50 may perform so-called "overwrite save" in which the unedited image file is replaced with the edited image file, or may perform so-called "save with different name" in which the edited image file is additionally saved while leaving the unedited image file.

In this way, in a case where processing of step S506 has been executed (a case where the verification of the authenticities of both of the original image data and metadata has succeeded), new authenticity ensuring information configured to ensure the authenticities of both of the edited image data and metadata on an individual basis is added to the edited image file (e.g., the image file 600B). On the other hand, in a case where processing of step S505 has been executed (a case where the verification of the authenticity of the original image data has succeeded and the verification of the authenticity of the original metadata has failed), new authenticity ensuring information configured to ensure the authenticity of the edited image data without ensuring the authenticity of the edited metadata is added to the edited image file (e.g., the image file 600C). In a case where processing of steps S505 and S506 has not been executed (a case where the verification of the authenticity of the original image data has failed or the original image file does not include authenticity ensuring information), new authenticity ensuring information is not added to an edited image file (not shown). In this case, the system control unit 50 may append, to a header of the edited image file, a flag indicating that the authenticity ensuring information 617 is now old information.

As described above, the second embodiment relates to exemplary processing for a case where authenticity ensuring information (first authenticity ensuring information) is configured to ensure the authenticities of main image data and metadata on an individual basis, as with the image file 600A of FIG. 6A, for example. In a case where the verification of the authenticities of both of original image data (first image data) and metadata (first metadata) has succeeded, the digital camera 100 performs control to include, in an edited image file (e.g., the image file 600B), authenticity ensuring information (second authenticity ensuring information) configured to ensure the authenticities of image data (second image data) that already reflects the image editing processing and metadata (second metadata) that already reflects the image editing processing on an individual basis. In a case where the verification of the authenticity of the first image data has succeeded but the verification of the authenticity of the first metadata has failed, the digital camera 100 performs control to include, in the edited image file (e.g., the image file 600C), authenticity ensuring information (second authenticity ensuring information) configured to ensure the authenticity of the second image data without ensuring the authenticity of the second metadata. In a case where the verification of the authenticity of the first image data has failed or the original image file does not include authenticity ensuring information, the digital camera 100 performs control to refrain from including second authenticity ensuring information in the edited image file.

Therefore, according to the present embodiment, in a case where image editing processing has been executed that triggers a change in metadata, such as image rotation, but does not trigger a change in image data, new authenticity ensuring information can be added to an edited image file if the verification of the authenticity of the original image data has succeeded, regardless of the result of the verification of the authenticity of the original metadata.

Note that the example of FIGS. 6A and 6B is illustrated in such a manner that a hash value of a main image and a hash value of metadata are included inside a block of one piece of authenticity ensuring information (e.g., the authenticity ensuring information 617). However, a specific arrangement of the hash value of the main image and the hash value of the metadata in an image file is not limited to the example of FIGS. 6A and 6B. For example, authenticity ensuring information including the hash value of the main image and authenticity ensuring information including the hash value of the metadata may be included separately in the image file 600A. In this case, information including a combination of the authenticity ensuring information including the hash value of the main image and the authenticity ensuring information including the hash value of the metadata is equivalent to an example of authenticity ensuring information configured to ensure the authenticities of main image data and metadata on an individual basis.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-224302, filed December 19, 2024, which is hereby incorporated by reference herein in its entirety.

What is claimed is:

1. An image processing apparatus, comprising:
a generation unit configured to generate a second image file by executing image editing processing on a first image file including first image data, the second image file including second image data that reflects the image editing processing;
a verification unit configured to, in a case where the first image file includes first authenticity ensuring information configured to ensure authenticity of the first image data, verify authenticity of the first image data based on the first authenticity ensuring information; and
a control unit configured to perform control to
in a case where the verification of authenticity of the first image data succeeds, include second authenticity ensuring information configured to ensure authenticity of the second image data in the second image file, and
in a case where the verification of authenticity of the first image data fails or the first image file does not include the first authenticity ensuring information, refrain from including the second authenticity ensuring information in the second image file.

2. The image processing apparatus according to claim 1, wherein
the first image file includes first metadata,
the second image file includes second metadata,
the first authenticity ensuring information is configured to ensure authenticity of the first image data and authenticity of the first metadata in an integrated manner, and
the second authenticity ensuring information is configured to ensure authenticity of the second image data and authenticity of the second metadata in an integrated manner.

3. The image processing apparatus according to claim 2, wherein
the image editing processing includes processing that triggers a change in the first metadata, and
the second metadata is metadata that reflects the image editing processing.

4. The image processing apparatus according to claim 2, wherein
the first authenticity ensuring information includes a hash value calculated based on a combination of the first image data and the first metadata, and
the second authenticity ensuring information includes a hash value calculated based on a combination of the second image data and the second metadata.

5. The image processing apparatus according to claim 1, wherein
the first authenticity ensuring information includes a hash value calculated based on the first image data, and
the second authenticity ensuring information includes a hash value calculated based on the second image data.

6. The image processing apparatus according to claim 1, wherein
the first image file includes first metadata,
the image editing processing includes processing that triggers a change in the first metadata,
the second image file includes second metadata that reflects the image editing processing,
the first authenticity ensuring information is configured to ensure authenticity of the first image data and authenticity of the first metadata on an individual basis,
the verification unit verifies authenticity of the first metadata based on the first authenticity ensuring information, and
in a case where the verification of authenticity of the first image data succeeds, the control unit is configured to perform control to:
if the verification of authenticity of the first metadata succeeds, configure the second authenticity ensuring information to ensure authenticity of the second image data and authenticity of the second metadata on an individual basis; and
if the verification of authenticity of the first metadata fails, configure the second authenticity ensuring information to ensure authenticity of the second image data without ensuring authenticity of the second metadata.

7. The image processing apparatus according to claim 6, wherein
the first authenticity ensuring information includes a hash value calculated based on the first image data, and a hash value calculated based on the first metadata,
in a case where the verification of authenticity of the first metadata succeeds, the second authenticity ensuring information includes a hash value calculated based on the second image data, and a hash value calculated based on the second metadata, and
in a case where the verification of authenticity of the first metadata fails, the second authenticity ensuring information does not include the hash value calculated based on the second metadata but includes the hash value calculated based on the second image data.

8. An image capturing apparatus, comprising:
the image processing apparatus according to claim 1; and
a shooting unit configured to shoot an image corresponding to the first image data.

9. An image processing method executed by an image processing apparatus, comprising:
generating a second image file by executing image editing processing on a first image file including first image data, the second image file including second image data that reflects the image editing processing;
in a case where the first image file includes first authenticity ensuring information configured to ensure authenticity of the first image data, verifying authenticity of the first image data based on the first authenticity ensuring information; and
performing control to
in a case where the verification of authenticity of the first image data succeeds, include second authenticity ensuring information configured to ensure authenticity of the second image data in the second image file, and
in a case where the verification of authenticity of the first image data fails or the first image file does not include the first authenticity ensuring information, refrain from including the second authenticity ensuring information in the second image file.

10. A non-transitory computer-readable storage medium which stores a program for causing a computer to execute an image processing method comprising:
generating a second image file by executing image editing processing on a first image file including first image data, the second image file including second image data that reflects the image editing processing;
in a case where the first image file includes first authenticity ensuring information configured to ensure authenticity of the first image data, verifying authenticity of the first image data based on the first authenticity ensuring information; and
performing control to
in a case where the verification of authenticity of the first image data succeeds, include second authenticity ensuring information configured to ensure authenticity of the second image data in the second image file, and
in a case where the verification of authenticity of the first image data fails or the first image file does not include the first authenticity ensuring information, refrain from including the second authenticity ensuring information in the second image file.
